(19) United States
(12) Patent Application Publication
(10) Pub. No.: US 2026/0184975 A1
(43) Pub. Date: Jul. 2, 2026

(54) DUAL-CURING SEMI-STRUCTURAL ADHESIVE COMPOSITION AND PREPARATION METHOD THEREOF

(71) Applicant: 3M INNOVATIVE PROPERTIES COMPANY, St. Paul, MN (US)

(72) Inventors: Heng Yu Huan, Shanghai (CN); Zhung Wang, Shanghai (CN); Lijing Zhang, Shanghai (CN)

(21) Appl. No.: 19/129,388

(22) PCT Filed: Dec. 1, 2023
(86) PCT No.: PCT/IB2023/062147

§ 371 Date: May 13, 2025

(30) Foreign Application Priority Data
Dec. 6, 2022 (CN) 202211560075.6

(51) Int. Cl. C09J 163/00; C09J 133/06

(52) U.S. Cl. CPC C09J 163/00; C09J 133/068

(57) ABSTRACT

The present invention provides a dual-curing semi-structural adhesive composition and a preparation method therefor. Specifically, the dual-curing semi-structural adhesive composition includes: an acrylic copolymer containing an acryloxy benzophenone copolymerized unit and an epoxidized acrylic copolymerized unit; an epoxy resin; a polyol; and a cationic photoinitiator. When the dual-curing semi-structural adhesive composition according to the technical solution of the present invention is used to adhere an adherend, the dual-curing semi-structural adhesive composition can immediately produce strong initial tack through primary curing by means of ultraviolet radiation, thus preventing the adherend from warping or sliding, and can produce firm final cured adhesion by means of subsequent cationic secondary curing.

### TECHNICAL FIELD

The present invention relates to the field of structural adhesives, and in particular, the present invention provides a dual-curing semi-structural adhesive composition and a preparation method therefor.

### BACKGROUND

Ultraviolet-initiated semi-structural adhesives are able to provide high adhesive strength, even comparable to the adhesive strength of liquid structural adhesives in certain applications. However, the curing process of currently used ultraviolet-initiated semi-structural adhesives is generally slow, requiring several hours to achieve basic cohesive strength. The foregoing causes the problem of an adherend tending to warp or slide after adhesion. In practical applications, after the semi-structural adhesive is applied, additional means such as pressing or clamping are required to prevent the adherend from warping or sliding during the curing process.

Therefore, it is of great significance to develop a semi-structural adhesive that can immediately produce sufficient initial tack when applied to an adherend and can provide strong adhesion after final curing.

### SUMMARY

Starting from the technical problem set forth above, the purpose of the present invention is to provide a dual-curing semi-structural adhesive composition and a preparation method therefor. The dual-curing semi-structural adhesive composition can immediately produce strong initial tack when used to adhere an adherend, thus preventing the adherend from warping or sliding, and can produce firm final cured adhesion by means of subsequent secondary curing.

The inventors have conducted intensive and detailed research to accomplish the present invention.

According to one aspect of the present invention, a dual-curing semi-structural adhesive composition is provided, comprising an acrylic copolymer, comprising an acryloxy benzophenone copolymerized unit and an epoxidized acrylic copolymerized unit; an epoxy resin; a polyol; and a cationic photoinitiator.

According to another aspect of the present invention, a method for preparing a dual-curing semi-structural adhesive composition is provided, comprising uniformly mixing components of the foregoing dual-curing semi-structural adhesive composition.

Compared to existing techniques in the art, the present invention has the following advantages: when used to adhere an adherend, the dual-curing semi-structural adhesive composition can immediately produce strong initial tack through primary curing by means of ultraviolet radiation, thus preventing the adherend from warping or sliding, and can produce firm final cured adhesion by means of subsequent cationic secondary curing.

### DETAILED DESCRIPTION

It should be appreciated that various other embodiments could be devised and modified by a person skilled in the art in light of the teachings of the present description without departing from the scope or spirit of the present disclosure. Therefore, the following particular embodiments are not limited in meaning.

Unless otherwise indicated, all numbers used in the present description and claims for the dimensions, quantities, and physicochemical properties of features should be construed to be modified by the term “approximately” in all instances. Accordingly, unless indicated to the contrary, the numerical parameter averages set forth in the description and appended claims are approximations that can be appropriately altered by those skilled in the art by utilizing the teachings disclosed herein to seek to obtain desired properties. The use of numerical ranges indicated by endpoints includes all numbers within said ranges and any range within said ranges; for example, 1 to 5 includes 1, 1.1, 1.3, 1.5, 2, 2.75, 3, 3.80, 4, 5, etc.

Currently, what is desired in the art is to develop a semi-structural adhesive that can immediately produce sufficient initial tack when applied to an adherend and can provide strong adhesion after final curing. The inventors of the present invention found in research that the above technical problem can be solved by using an acrylic copolymer having a specific structure in a semi-structural adhesive. The acrylic copolymer simultaneously includes: a copolymerized unit that can initiate crosslinking via ultraviolet radiation, which can immediately increase the cohesive strength of the semi-structural adhesive after ultraviolet radiation, thus preventing an adherend from warping or sliding after adhesion; and a cationically crosslinkable copolymerized unit that can polymerize with an epoxy resin by means of cationic reaction, which can provide high adhesion strength after final curing.

Specifically, according to one aspect of the present invention, a dual-curing semi-structural adhesive composition is provided, including: an acrylic copolymer, including an acryloxy benzophenone copolymerized unit and an epoxidized acrylic copolymerized unit; an epoxy resin; a polyol; and a cationic photoinitiator.

According to the technical solution of the present invention, the dual-curing semi-structural adhesive composition includes the acrylic copolymer, and the acrylic copolymer includes the acryloxy benzophenone copolymerized unit and the epoxidized acrylic copolymerized unit. During an application process of the dual-curing semi-structural adhesive composition, the acryloxy benzophenone copolymerized unit can abstract active hydrogen in a system via ultraviolet radiation, thereby initiating pre-crosslinking by means of free radical reaction, which can increase the cohesive strength of the semi-structural adhesive immediately after ultraviolet radiation, thus preventing an adherend from warping or sliding after adhesion. In addition, the epoxidized acrylic copolymerized unit can polymerize with the epoxy resin by means of cationic reaction in a further curing process, thereby providing high adhesion strength after final curing.

There is no particular limitation to the number average molecular weight of the acrylic copolymer. Preferably, the number average molecular weight of the acrylic copolymer is in the range of 500,000-800,000. When the number average molecular weight of the acrylic copolymer is selected within the range of 500,000-800,000, the resulting dual-curing semi-structural adhesive composition can have good film-forming properties, and at the same time, the acrylic copolymer, the epoxy resin, and the polyol will have good compatibility therebetween.

Preferably, a comonomer forming the acryloxy benzophenone copolymerized unit is one or more selected from 4-acryloyloxy benzophenone, 4-acryloyloxyethoxy benzophenone, 4-acryloyloxybutoxy benzophenone, and the like. According to certain preferred embodiments of the present invention, the acryloxy benzophenone copolymerized unit accounts for 0.05-1 wt %, preferably 0.5-1 wt %, of the acrylic copolymer having a total weight of 100%. The acryloxy benzophenone copolymerized unit is copolymerized into polymer segments of the acrylic copolymer and remains stable until being excited by receiving ultraviolet radiation. Compared to the epoxidized acrylic copolymerized unit, the acryloxy benzophenone copolymerized unit is instantly crosslinked after being excited by ultraviolet rays, which improves the overall degree of crosslinking and average molecular weight of the adhesive, thereby improving the cohesion and warping resistance of the adhesive during initial curing. In the acrylic copolymer, if the content of the acryloxy benzophenone copolymerized unit is too high, the free radical crosslinking density of the adhesive will be overly high, consequently reducing the wettability to a substrate, resulting in a low overall peel force of the adhesive upon completion of a subsequent cationic crosslinking reaction.

Preferably, a comonomer forming the epoxidized acrylic copolymerized unit is one or more selected from glycidyl methacrylate, oxetane methacrylate, and the like. According to certain preferred embodiments of the present invention, the epoxidized acrylic copolymerized unit accounts for 3-15 wt % of the acrylic copolymer having a total weight of 100%. The inventors have found that in the acrylic copolymer, if the proportion of the epoxidized acrylic copolymerized unit is overly small, the epoxidized acrylic copolymerized unit cannot have the effect of copolymerizing with the epoxy resin for toughening, and if the proportion of the epoxidized acrylic copolymerized unit is overly high, the crosslinking density will be high, which will affect the final peel force of the adhesive.

The acrylic copolymer further includes an acrylate copolymerized unit other than the acryloxy benzophenone copolymerized unit and the epoxidized acrylic copolymerized unit.

Preferably, the acrylate copolymerized unit other than the acryloxy benzophenone copolymerized unit and the epoxidized acrylic copolymerized unit includes: a high-Tg (glass transition temperature) acrylate copolymerized unit, wherein the Tg of a homopolymer of an acrylate comonomer forming the high-Tg acrylate copolymerized unit is higher than 20° C.; and a low-Tg (glass transition temperature) acrylate copolymerized unit, wherein the Tg of a homopolymer of an acrylate comonomer forming the low-Tg acrylate copolymerized unit is lower than 0° C.

Preferably, the acrylate comonomer forming the high-Tg acrylate copolymerized unit is one or more selected from butyl (meth)acrylate, 2-hydroxyethyl (meth)acrylate, iso-octyl (meth)acrylate, and 2-ethylhexyl (meth)acrylate. In addition, the acrylate comonomer forming the low-Tg acrylate copolymerized unit is one or more selected from methyl (meth)acrylate, isobornyl (meth)acrylate, (meth)acrylic acid, and acrylamide.

Preferably, the glass transition temperature of the acrylic copolymer is in the range of −15° C. to 0° C. According to the technical solution of the present invention, the glass transition temperature of the obtained acrylic copolymer is controlled to be within the above range by adjusting the ratio of the high-Tg acrylate copolymerized unit to the low-Tg acrylate copolymerized unit, so as to achieve good mechanical properties of the resulting dual-curing semi-structural adhesive composition.

According to the technical solution of the present invention, preferably, the dual-curing semi-structural adhesive composition includes 40-65 wt % of the acrylic copolymer on the basis that the total weight of the dual-curing semi-structural adhesive composition is 100%.

In addition to the acrylic copolymer described in detail above, the dual-curing semi-structural adhesive composition according to the invention further includes the epoxy resin. The epoxy resin is used to copolymerize with the epoxidized acrylic copolymerized unit during a cationic polymerization process to achieve firm final cured adhesion of the structural adhesive composition. There is no particular limitation to the specific type of epoxy resin that can be used in the present invention, and the epoxy resin can be appropriately selected from among conventional epoxy resin materials generally used in the field of structural adhesives. Preferably, the epoxy resin is a liquid epoxy resin or a semi-solid epoxy resin. Preferably, the epoxy equivalent of the epoxy resin is in the range of 76-500 eq/100 g. Commercial and economical epoxy resin products such as bisphenol A epoxy resin, bisphenol F epoxy resin, etc., can be used. Ester ring epoxy resins such as glycidyl ether obtained by reacting polyphenols such as hydrogenated bisphenol A, tetramethyl bisphenol A, diaryl bisphenol A, and tetramethyl bisphenol F with epichlorohydrin, as well as epoxidized polyolefins and other known epoxy resins, can be used.

Preferably, the dual-curing semi-structural adhesive composition includes 30-50 wt % of the epoxy resin on the basis that the total weight of the dual-curing semi-structural adhesive composition is 100%. The inventors of the present application have found that the amount of the epoxy resin is primarily related to the cohesive strength, such as shear strength, of the adhesive after curing. If the amount of the epoxy resin is overly small, the shear strength of the cured adhesive is insufficient. If the amount of the epoxy resin is overly high, the film-forming stability of the adhesive before curing will be affected, and the adhesive will be overly brittle after curing, thus reducing the peel force.

In addition to the acrylic copolymer and the epoxy resin described in detail above, the dual-curing semi-structural adhesive composition according to the present invention further includes the polyol. The polyol is a compound containing two or more hydroxyl groups. Preferably, the polyol is a polyether polyol. More preferably, the polyol is a polyether diol, a polyether triol, or the like. Preferably, the polyol has a weight average molecular weight in the range of 500-3000 g/mol. When the weight average molecular weight of the polyol is selected within the range of 500-3000 g/mol, components such as the acrylic copolymer, the epoxy resin and the polyol can be provided with good compatibility and reactivity.

Commercially available examples of polyols that can be used in the present invention include, for example, TONE 0230 Polyol, VORANOL 230-238, and Varonol 2070 from Dow Chemical (USA), Dianol 285 from Seppic Corporation (France), and the like. In some preferred embodiments, Varonol 2070, a polyether triol having a molecular weight of 700, available from Dow Chemical, USA, is used.

Preferably, the dual-curing semi-structural adhesive composition includes 3-12 wt % of the polyol on the basis that the total weight of the dual-curing semi-structural adhesive composition is 100%. The polyol functions to adjust the speed of light-induced cationic polymerization in the dual-curing semi-structural adhesive composition, and can be polymerized into a crosslinked network of epoxy groups to adjust the curing flexibility of the composition. If the content of the polyol is overly low, the curing speed will be fast but the adhesive will be brittle and the peel force will be low; if the content of the polyol is overly high, the film-forming stability of the adhesive before curing will be poor, the curing speed will be slow, and the adhesive will be overly soft, thus affecting the shear strength.

In addition to the acrylic copolymer, the epoxy resin and the polyol described in detail above, the dual-curing semi-structural adhesive composition according to the present invention further includes the cationic photoinitiator. There is no particular limitation to the specific type of cationic photoinitiator that can be used in the present invention, and the cationic photoinitiator can be appropriately selected from among conventional cationic photoinitiators generally used to initiate cationic polymerization of epoxides. Preferably, the cationic photoinitiator is one or more selected from a diazonium salt, an iodonium salt, a sulfonium salt, an antimonate, and an iron arene. Specific examples of the cationic photoinitiator include triaryl hexafluoroantimonates, diaryliodonium salts, arylsulfonium salts, alkylsulfonium salts, iron arene salts, sulfonyloxy ketones, and triarylsiloxanes, etc. In addition, triaryl hexafluoroantimonate (product name: Doublecure 1176) produced by Double Bond Chemical Co., Ltd. can be used.

According to certain embodiments of the present invention, the dual-curing semi-structural adhesive composition includes 0.02-3 wt %, preferably 0.5-2.5 wt %, of the cationic photoinitiator on the basis that the total weight of the dual-curing semi-structural adhesive composition is 100%. If the content of the cationic photoinitiator is overly low, the reaction speed is slow, and the curing process is easily affected by moisture inhibition, resulting in incomplete final curing. If the content of the cationic photoinitiator is too high, the curing speed is overly fast, and the crosslinked network structure is more brittle.

According to another aspect of the present invention, a method for preparing a dual-curing semi-structural adhesive composition is provided, including uniformly mixing the components of the foregoing dual-curing semi-structural adhesive composition. There are no special requirements for a specific process for mixing, and the mixing can be done manually or mechanically at room temperature.

The following detailed description is intended to illustrate, not limit, the present disclosure by way of example.

Embodiment 1 is a dual-curing semi-structural adhesive composition, including: an acrylic copolymer, including an acryloxy benzophenone copolymerized unit and an epoxidized acrylic copolymerized unit; an epoxy resin; a polyol; and a cationic photoinitiator.

Embodiment 2 is the dual-curing semi-structural adhesive composition according to Embodiment 1, wherein a comonomer forming the acryloxy benzophenone copolymerized unit is one or more selected from 4-acryloyloxy benzophenone, 4-acryloyloxyethoxy benzophenone, and 4-acryloyloxybutoxy benzophenone.

Embodiment 3 is the dual-curing semi-structural adhesive composition according to Embodiment 1, wherein the acryloxy benzophenone copolymerized unit accounts for 0.05-1 wt % of the acrylic copolymer having a total weight of 100%.

Embodiment 4 is the dual-curing semi-structural adhesive composition according to Embodiment 1, wherein the acryloxy benzophenone copolymerized unit accounts for 0.5-1 wt % of the acrylic copolymer having a total weight of 100%.

Embodiment 5 is the dual-curing semi-structural adhesive composition according to Embodiment 1, wherein a comonomer forming the epoxidized acrylic copolymerized unit is one or more selected from glycidyl methacrylate and oxetane methacrylate.

Embodiment 6 is the dual-curing semi-structural adhesive composition according to Embodiment 1, wherein the epoxidized acrylic copolymerized unit accounts for 3-15 wt % of the acrylic copolymer having a total weight of 100%.

Embodiment 7 is the adhesive composition according to Embodiment 1, wherein the acrylic copolymer further includes an acrylate copolymerized unit other than the acryloxy benzophenone copolymerized unit and the epoxidized acrylic copolymerized unit.

Embodiment 8 is the dual-curing semi-structural adhesive composition according to Embodiment 1, wherein the acrylate copolymerized unit other than the acryloxy benzophenone copolymerized unit and the epoxidized acrylic copolymerized unit includes:
a high-Tg acrylate copolymerized unit, wherein the Tg of a homopolymer of an acrylate comonomer forming the high-Tg acrylate copolymerized unit is higher than 20° C.; and
a low-Tg acrylate copolymerized unit, wherein the Tg of a homopolymer of an acrylate comonomer forming the low-Tg acrylate copolymerized unit is lower than 0° C.

Embodiment 9 is the dual-curing semi-structural adhesive composition according to Embodiment 8, wherein the acrylate comonomer forming the high-Tg acrylate copolymerized unit is one or more selected from butyl (meth)acrylate, 2-hydroxyethyl (meth)acrylate, iso-octyl (meth)acrylate, and 2-ethylhexyl (meth)acrylate.

Embodiment 10 is the dual-curing semi-structural adhesive composition according to Embodiment 8, wherein the acrylate comonomer forming the low-Tg acrylate copolymerized unit is one or more selected from methyl (meth)acrylate, isobornyl (meth)acrylate, (meth)acrylic acid, and acrylamide.

Embodiment 11 is the dual-curing semi-structural adhesive composition according to Embodiment 1, wherein the dual-curing semi-structural adhesive composition includes 40-65 wt % of the acrylic copolymer on the basis that the total weight of the dual-curing semi-structural adhesive composition is 100%.

Embodiment 12 is the dual-curing semi-structural adhesive composition according to Embodiment 1, wherein the epoxy resin is a liquid epoxy resin or a semi-solid epoxy resin.

Embodiment 13 is the dual-curing semi-structural adhesive composition according to Embodiment 1, wherein the epoxy equivalent of the epoxy resin is in the range of 76-500 eq/100 g.

Embodiment 14 is the dual-curing semi-structural adhesive composition according to Embodiment 1, wherein the dual-curing semi-structural adhesive composition includes 30-50 wt % of the epoxy resin on the basis that the total weight of the dual-curing semi-structural adhesive composition is 100%.

Embodiment 15 is the dual-curing semi-structural adhesive composition according to Embodiment 1, wherein the polyol is a compound containing two or more hydroxyl groups.

Embodiment 16 is the dual-curing semi-structural adhesive composition according to Embodiment 1, wherein the polyol is a polyether polyol.

Embodiment 17 is the dual-curing semi-structural adhesive composition according to Embodiment 1, wherein the polyol is a polyether diol or a polyether triol.

Embodiment 18 is the dual-curing semi-structural adhesive composition according to Embodiment 1, wherein the weight average molecular weight of the polyol is in the range of 500-3000 g/mol.

Embodiment 19 is the dual-curing semi-structural adhesive composition according to Embodiment 1, wherein the dual-curing semi-structural adhesive composition includes 3-12 wt % of the polyol on the basis that the total weight of the dual-curing semi-structural adhesive composition is 100%.

Embodiment 20 is the dual-curing semi-structural adhesive composition according to Embodiment 1, wherein the cationic photoinitiator is one or more selected from a diazonium salt, an iodonium salt, a sulfonium salt, an antimonate, and an iron arene.

Embodiment 21 is the dual-curing semi-structural adhesive composition according to Embodiment 1, and Embodiment 2 is the dual-curing semi-structural adhesive composition according to Embodiment 1.

Embodiment 22 is a method for preparing a dual-curing semi-structural adhesive composition, including uniformly mixing components of the dual-curing semi-structural adhesive composition according to any one of Embodiments 1 to 21.

The present invention will be described in more detail below with reference to examples. It should be pointed out that these descriptions and examples are for the purpose of facilitating the understanding of the present invention, rather than limiting the present invention. The scope of protection of the present invention is subject to the appended claims.

### EXAMPLES

In the present invention, unless otherwise indicated, reagents used are all commercially available products which are used directly without further purification. In addition, in the present invention, “%” means “wt %” unless otherwise specified.

TABLE 1
List of Raw Materials

| Product Name | Product Details | Supplier |
|---|---|---|
| NPES 128 | Liquid bisphenol A-type epoxy resin having an | Nanya Chemical |
| | epoxy equivalent of 184-190 eq/100 g | Company |
| NPES 901 | Solid bisphenol A-type epoxy resin having an epoxy | Nanya Chemical |
| | equivalent of 450-500 eq/100 g | Company |
| Varonol 2070 | Polyether triol having a weight average molecular | Dow Chemical Co., Ltd. |
| | weight of 700 | |
| Doublecure 1176 | Triaryl hexafluoroantimonate cationic photoinitiator | Double Bond Chemical |
| | | Company |
| Benzophenone | | Sinopharm Chemical |
| | | Company |

### Test Methods

### Anti-Warping

In the present invention, the anti-warping property of an adhesive film was characterized by the 1 min shear strength of the adhesive film by means of using a GB/T 7124-2008 method. The 1 min shear strength of the adhesive film refers to the shear strength of the adhesive film at 1 minute after attaching the adhesive film to a substrate. Specifically, a release layer of adhesive tapes prepared in the following examples or comparative examples was peeled off, and the adhesive film was attached on an aluminum plate (dimensions: 1 inch×4 inches). Then, a glass plate (dimensions: 1 inch×4 inches×1 mm thick) was laminated, with displacement, on the side of the aluminum plate to which the adhesive film was attached, so that the area of an overlapping region having the laminated structure of the aluminum plate/adhesive film/glass plate was 1 inch× ½ inch. Then, the adhesive film sandwiched between the aluminum plate and the glass plate was irradiated using 3000 mJ/cm² of ultraviolet energy, passing through the glass plate, by a 365-nm LED ultraviolet curing machine produced by UVATA, and when the ultraviolet radiation was carried out for 1 minute, the shear strength was immediately measured using the GB/T 7124-2008 method.

If the measured 1 min shear strength was greater than or equal to 0.2 MPa, the adhesive film would not cause the warping or sliding of an adherend during use, and the adhesive film could be handled immediately during production and assembly processes. If the measured 1 min shear strength was greater than or equal to 0.3 MPa, the anti-warping property of the adhesive film was considered to be excellent. If the measured 1 min was less than 0.2 MPa, the adhesive film would cause warping or sliding of the adherend during use.

180° Peel Strength after Final Curing

In the present invention, an ASTM D3300 method was used to test one of the adhesive properties after final curing of the adhesive film, i.e., the 180° peel strength. Specifically, an adhesive composition prepared in the following examples or comparative examples was coated on a polyethylene terephthalate film (PET film) having a thickness of 100 μm by means of using a comma bar coater so that the thickness of the adhesive film was 35 μm. Then, the adhesive film (½ inch×6 inches) was irradiated with 3000 mJ/cm² of ultraviolet energy by a 365 nm

LED ultraviolet curing machine produced by UVATA, and the irradiated adhesive film was attached to an aluminum plate (dimensions: 2 inches×4 inches) within 1 minute. Subsequently, the obtained laminate was cured at 80° C. for 1 hour. Finally, the 180° peel strength was tested using the ASTM D3300 method.

If the measured 180° peel strength after final curing was greater than or equal to 0.4 N/mm, the adhesive film was considered to be capable of achieving firm final cured adhesion. If the measured 180° peel strength after final curing was greater than or equal to 0.6 N/mm, the adhesiveness of the adhesive film after final curing was considered to be excellent. If the measured 180° peel strength after final curing was less than 0.4 N/mm, the adhesiveness of the adhesive film after final curing was considered to not be able to meet practical application adhesion requirements.

Shear Strength after Final Curing

In the present invention, a GB/T 7124-2008 method was used to test one of the adhesive properties after final curing of the adhesive film, i.e., shear strength. Specifically, the adhesive composition prepared in the following examples or comparative examples was coated on a polyethylene terephthalate film (PET film) having a thickness of 50 μm by means of using a comma bar coater so that the thickness of the adhesive film was 100 μm. Then, the adhesive film (1 inch×1 inch) was irradiated with 3000 mJ/cm² of ultraviolet energy by a 365 nm LED ultraviolet curing machine produced by UVATA, the PET film was peeled, and the irradiated adhesive film was attached to an aluminum plate (dimensions: 1 inch×4 inches) within 1 minute. Subsequently, the obtained laminate of the adhesive film/aluminum plate was cured at 80° C. for 1 hour. Then, an epoxy structural adhesive (DP100, produced by 3M) having a thickness of about 200 μm and an aluminum plate (size: 1 inch×4 inches) were sequentially arranged on the adhesive film side of the laminate to obtain a laminated structure of aluminum plate/adhesive film/epoxy structural adhesive/aluminum plate, wherein the area of an overlapping region of the two opposite aluminum plates was 1 inch×½ inch. Subsequently, the laminate continued to be cured at 80° C. for 2 hours. Finally, the shear strength was measured by using the GB/T 7124-2008 method.

If the measured shear strength after final curing was greater than or equal to 5 MPa, the adhesive film was considered to be capable of achieving firm final cured adhesion. If the measured shear strength after final curing was greater than or equal to 7 MPa, the adhesiveness of the adhesive film after final curing was considered to be excellent. If the measured shear strength after final curing was less than 5 MPa, the adhesiveness of the adhesive film after final curing was considered to not be able to meet practical application adhesion requirements.

### Preparation Example 1 (Preparation of Acrylic Copolymer 1 (55% BA/29% MA/8% 2-HEA/8% GMA))

100 g of acrylic monomers (including 55 g of butyl acrylate (BA), 29 g of methyl acrylate (MA), 8 g of 2-hydroxyethyl acrylate (2-HEA), and 8 g of glycidyl methacrylate (GMA)), 150 g of ethyl acetate, and 0.2 g of Vazo 67 initiator (produced by BASF) were added into a 500 ml three-neck flask according to the above mass ratio. A pneumatic stirrer was turned on to a speed of 100-150 rpm (ZD-J-1 type, Shanghai Zuoda Coating Equipment Co., Ltd.), and the temperature was raised to 60° C. to carry out reaction for 24 hours to obtain a viscous acrylic copolymer solution having a solids content of 40%. An acrylic copolymer was then separated from the acrylic copolymer solution as a solid for further use.

### Preparation Example 2 (Preparation of acrylic copolymer 2 (55% BA/29% MA/8% 2-HEA/8% GMA/1% ABP))

101 g of acrylic monomers (including 55 g of butyl acrylate (BA), 29 g of methyl acrylate (MA), 8 g of 2-hydroxyethyl acrylate (2-HEA), 8 g of glycidyl methacrylate (GMA) and 1 g of 4-acryloyloxy benzophenone (ABP)), 150 g of ethyl acetate, and 0.2 g of Vazo 67 initiator (produced by BASF) were added into a 500 ml three-neck flask according to the above mass ratio. A pneumatic stirrer was turned on to a speed of 100-150 rpm (ZD-J-1 type, Shanghai Zuoda Coating Equipment Co., Ltd.), and the temperature was raised to 60° C. to carry out reaction for 24 hours to obtain a viscous acrylic copolymer solution having a solids content of 40%. An acrylic copolymer was then separated from the acrylic copolymer solution as a solid for further use.

### Preparation Example 3 (Preparation of acrylic copolymer 3 (55% BA/29% MA/8% 2-HEA/8% GMA/0.5% ABP))

100.5 g of acrylic monomers (including 55 g of butyl acrylate (BA), 29 g of methyl acrylate (MA), 8 g of 2-hydroxyethyl acrylate (2-HEA), 8 g of glycidyl methacrylate (GMA), and 0.5 g of 4-acryloyloxy benzophenone (ABP)), 150 g of ethyl acetate, and 0.2 g of Vazo 67 initiator (produced by BASF) were added into a 500 ml three-neck flask according to the above mass ratio. A pneumatic stirrer was turned on to a speed of 100-150 rpm (ZD-J-1 type, Shanghai Zuoda Coating Equipment Co., Ltd.), and the temperature was raised to 60° C. to carry out reaction for 24 hours to obtain a viscous acrylic copolymer solution having a solids content of 40%. An acrylic copolymer was then separated from the acrylic copolymer solution as a solid for further use.

### Preparation Example 4 (Preparation of acrylic copolymer 4 (55% BA/29% MA/8% 2-HEA/8% GMA/0.05% ABP))

100.05 g of acrylic monomers (including 55 g of butyl acrylate (BA), 29 g of methyl acrylate (MA), 8 g of 2-hydroxyethyl acrylate (2-HEA), 8 g of glycidyl methacrylate (GMA), and 0.05 g of 4-acryloyloxy benzophenone (ABP)), 150 g of ethyl acetate, and 0.2 g of Vazo 67 initiator (produced by BASF) were added into a 500 ml three-neck flask according to the above mass ratio. A pneumatic stirrer was turned on to a speed of 100-150 rpm (ZD-J-1 type, Shanghai Zuoda Coating Equipment Co., Ltd.), and the temperature was raised to 60° C. to carry out reaction for 24 hours to obtain a viscous acrylic copolymer solution having a solids content of 40%. An acrylic copolymer was then separated from the acrylic copolymer solution as a solid for further use.

### Preparation Example 5 (Preparation of acrylic copolymer 5 (57% BA/29.5% MA/8% 2-HEA/3% GMA/0.5% ABP))

98 g of acrylic monomers (including 57 g of butyl acrylate (BA), 29.5 g of methyl acrylate (MA), 8 g of 2-hydroxyethyl acrylate (2-HEA), 3 g of glycidyl methacrylate (GMA), and 0.5 g of 4-acryloyloxy benzophenone (ABP)), 150 g of ethyl acetate, and 0.2 g of Vazo 67 initiator (produced by BASF) were added into a 500 ml three-neck flask according to the above mass ratio. A pneumatic stirrer was turned on to a speed of 100-150 rpm (ZD-J-1 type, Shanghai Zuoda Coating Equipment Co., Ltd.), and the temperature was raised to 60° C. to carry out reaction for 24 hours to obtain a viscous acrylic copolymer solution having a solids content of 40%. An acrylic copolymer was then separated from the acrylic copolymer solution as a solid for further use.

### Preparation Example 6 (Preparation of acrylic copolymer 6 (51% BA/25.5% MA/8% 2-HEA/15% GMA/0.5% ABP))

100 g of acrylic monomers (including 51 g of butyl acrylate (BA), 25.5 g of methyl acrylate (MA), 8 g of 2-hydroxyethyl acrylate (2-HEA), 15 g of glycidyl methacrylate (GMA), and 0.5 g of 4-acryloyloxy benzophenone (ABP)), 150 g of ethyl acetate, and 0.2 g of Vazo 67 initiator (produced by BASF) were added into a 500 ml three-neck flask according to the above mass ratio. A pneumatic stirrer was turned on to a speed of 100-150 rpm (ZD-J-1 type, Shanghai Zuoda Coating Equipment Co., Ltd.), and the temperature was raised to 60° C. to carry out reaction for 24 hours to obtain a viscous acrylic copolymer solution having a solids content of 40%. An acrylic copolymer was then separated from the acrylic copolymer solution as a solid for further use.

### Example 1

45 g of the acrylic copolymer 2 prepared as above, 40 g of epoxy resin NPES 128, 5 g of epoxy resin NPES 901, 8 g of polyol Varonol 2070 and 2 g of cationic photoinitiator Doublecure 1176 were evenly mixed to prepare an adhesive composition 1. The types of raw materials used to prepare the adhesive composition 1 and the content ranges thereof are shown in Table 2 below. The adhesive composition 1 was coated on a PET film, and a solvent was dried to obtain an adhesive composition tape 1.

The corresponding properties of the obtained adhesive composition 1 were tested according to the methods for testing the anti-warping property, the 180° peel strength after final curing, and the shear strength after final curing as described in detail above, and the results are shown in Table 2 below.

### Examples 2-9 and Comparative Examples 1-2

Adhesive compositions were prepared in a similar manner to that of Example 1, except that the types of raw materials of the adhesive compositions and the contents thereof were changed as shown in Table 2 below.

The corresponding properties of the obtained adhesive compositions were tested according to the methods for testing the anti-warping property, the 180° peel strength after final curing, and the shear strength after final curing as described in detail above, and the results are shown in Table 2 below.

TABLE 2
Raw material compositions of adhesive compositions used for preparing Examples 1-9
and Comparative Examples 1-2 and property test results of obtained adhesive compositions

| | Example | Example | Example | Example | Example | Example | Example | Example | Example | Comparative | Comparative |
|---|---|---|---|---|---|---|---|---|---|---|---|
| | 1 | 2 | 3 | 4 | 5 | 6 | 7 | 8 | 9 | Example 1 | Example 2 |
| Acrylic copolymer 1 | | | | | | | | | | 45 | 45 |
| Acrylic copolymer 2 | 45 | | | | | | | | | | |
| Acrylic copolymer 3 | | 45 | | | | 40 | 65 | 50 | 45 | | |
| Acrylic copolymer 4 | | | 45 | | | | | | | | |
| Acrylic copolymer 5 | | | | 45 | | | | | | | |
| Acrylic copolymer 6 | | | | | 45 | | | | | | |
| NPES 128 | 40 | 40 | 40 | 40 | 40 | 45 | 27 | 40 | 36 | 40 | 40 |
| NPES 901 | 5 | 5 | 5 | 5 | 5 | 5 | 3 | 5 | 5 | 5 | 5 |
| Varonol 2070 | 8 | 8 | 8 | 8 | 8 | 8 | 3 | 3 | 12 | 8 | 8 |
| Doublecure 1176 | 2 | 2 | 2 | 2 | 2 | 2 | 2 | 2 | 2 | 2 | 2 |
| ABP | | | | | | | | | | | 0.23 |
| Total | 100 | 100 | 100 | 100 | 100 | 100 | 100 | 100 | 100 | 100 | 100.23 |
| Anti-warping property | 0.45 | 0.43 | 0.21 | 0.4 | 0.42 | 0.28 | 0.52 | 0.48 | 0.20 | 0.08 | 0.08 |
| (1 min shear strength, | | | | | | | | | | | |
| unit: MPa) | | | | | | | | | | | |
| 180° peel strength after | 0.45 | 0.85 | 0.98 | 1.0 | 0.47 | 0.62 | 1.15 | 0.43 | 1.02 | 0.98 | 0.99 |
| final curing (unit: N/mm) | | | | | | | | | | | |
| Shear strength after final | 9.0 | 8.8 | 9.3 | 6.7 | 10.5 | 11.0 | 5.5 | 9.5 | 8.1 | 9.2 | 9.2 |
| curing (unit: MPa) | | | | | | | | | | | |

As can be seen from the results shown in Table 2 above, when a dual-curing semi-structural adhesive composition (for example, Examples 1-9) was prepared within the scope of the present invention, the resulting dual-curing semi-structural adhesive composition could immediately produce strong initial tack through primary curing by means of ultraviolet radiation when used to adhere an adherend, thus preventing the adherend from warping or sliding, and could produce firm final cured adhesion by means of subsequent cationic secondary curing.

In another aspect, as can be seen from the results of Comparative Example 1 shown in Table 2 above, when the acryloxy benzophenone copolymerized unit was not included in the acrylic copolymer, the structural adhesive could not immediately obtain sufficient cohesive strength by means of ultraviolet radiation after coating, and would warp or slide after adhesion.

As can be seen from the results of Comparative Example 2 shown in Table 2 above, when the acrylic copolymer did not include the acryloxy benzophenone copolymerized unit but used ABP as an externally-added initiator, crosslinking of the components of the adhesive after ultraviolet excitation could not be effectively induced, the average molecular weight of the adhesive could not be effectively increased, and the immediate shear strength at 1 min could not be significantly increased.

Although specific embodiments have been shown and described in the present invention, a person skilled in the art would understand that various alternative and/or equivalent embodiments may be used to substitute the specific embodiments shown and described without departing from the scope of the present invention. The present application is intended to encompass any adaptations or variations of the specific embodiments discussed in the present invention. Accordingly, the present invention is subject only to the claims and equivalents thereof.

A person skilled in the art should appreciate that various modifications and changes could be made without departing from the scope of the present invention. Such modifications and changes are intended to fall within the scope of the present invention as defined by the appended claims.

1. A dual-curing semi-structural adhesive composition, comprising:
an acrylic copolymer, comprising an acryloxy benzophenone copolymerized unit and an epoxidized acrylic copolymerized unit;
an epoxy resin;
a polyol; and
a cationic photoinitiator.

2. The dual-curing semi-structural adhesive composition according to claim 1, wherein a comonomer forming the acryloxy benzophenone copolymerized unit is one or more selected from 4-acryloyloxy benzophenone, 4-acryloyloxyethoxy benzophenone, and 4-acryloyloxybutoxy benzophenone.

3. The dual-curing semi-structural adhesive composition according to claim 1, wherein the acryloxy benzophenone copolymerized unit accounts for 0.05-1 wt % of the acrylic copolymer having a total weight of 100%.

4. The dual-curing semi-structural adhesive composition according to claim 1, wherein the acryloxy benzophenone copolymerized unit accounts for 0.5-1 wt % of the acrylic copolymer having a total weight of 100%.

5. The dual-curing semi-structural adhesive composition according to claim 1, wherein a comonomer forming the epoxidized acrylic copolymerized unit is one or more selected from glycidyl methacrylate and oxetane methacrylate.

6. The dual-curing semi-structural adhesive composition according to claim 1, wherein the epoxidized acrylic copolymerized unit accounts for 3-15 wt % of the acrylic copolymer having a total weight of 100%.

7. The dual-curing semi-structural adhesive composition according to claim 1, wherein the acrylic copolymer further comprises an acrylate copolymerized unit other than the acryloxy benzophenone copolymerized unit and the epoxidized acrylic copolymerized unit.

8. The dual-curing semi-structural adhesive composition according to claim 7, wherein the acrylate copolymerized unit other than the acryloxy benzophenone copolymerized unit and the epoxidized acrylic copolymerized unit comprises:
a high-Tg acrylate copolymerized unit, wherein the Tg of a homopolymer of an acrylate comonomer forming the high-Tg acrylate copolymerized unit is higher than 20° C.; and
a low-Tg acrylate copolymerized unit, wherein the Tg of a homopolymer of an acrylate comonomer forming the low-Tg acrylate copolymerized unit is lower than 0° C.

9. The dual-curing semi-structural adhesive composition according to claim 8, wherein the acrylate comonomer forming the high-Tg acrylate copolymerized unit is one or more selected from butyl (meth)acrylate, 2-hydroxyethyl (meth)acrylate, iso-octyl (meth)acrylate, and 2-ethylhexyl (meth)acrylate.

10. The dual-curing semi-structural adhesive composition according to claim 8, wherein the acrylate comonomer forming the low-Tg acrylate copolymerized unit is one or more selected from methyl (meth)acrylate, isobornyl (meth)acrylate, (meth)acrylic acid, and acrylamide.

11. The dual-curing semi-structural adhesive composition according to claim 1, wherein the dual-curing semi-structural adhesive composition comprises 40-65 wt % of the acrylic copolymer on the basis that the total weight of the dual-curing semi-structural adhesive composition is 100%.

12. The dual-curing semi-structural adhesive composition according to claim 1, wherein the epoxy resin is a liquid epoxy resin or a semi-solid epoxy resin.

13. The dual-curing semi-structural adhesive composition according to claim 1, wherein the epoxy equivalent of the epoxy resin is in the range of 76-500 eq/100 g.

14. The dual-curing semi-structural adhesive composition according to claim 1, wherein the dual-curing semi-structural adhesive composition comprises 30-50 wt % of the epoxy resin on the basis that the total weight of the dual-curing semi-structural adhesive composition is 100%.

15. The dual-curing semi-structural adhesive composition according to claim 1, wherein the polyol comprises one of a compound containing two or more hydroxyl groups, a polyether polyol, a polyether diol, and a polyether triol.

16-17. (canceled)

18. The dual-curing semi-structural adhesive composition according to claim 1, wherein the weight average molecular weight of the polyol is in the range of 500-3000 g/mol.

19. The dual-curing semi-structural adhesive composition according to claim 1, wherein the dual-curing semi-structural adhesive composition comprises 3-12 wt % of the polyol on the basis that the total weight of the dual-curing semi-structural adhesive composition is 100%.

20. The dual-curing semi-structural adhesive composition according to claim 1, wherein the cationic photoinitiator is one or more selected from a diazonium salt, an iodonium salt, a sulfonium salt, an antimonate, and an iron arene.

21. The dual-curing semi-structural adhesive composition according to claim 1, wherein the dual-curing semi-structural adhesive composition comprises 0.02-3 wt % of the cationic photoinitiator on the basis that the total weight of the dual-curing semi-structural adhesive composition is 100%.

22. A method for preparing a dual-curing semi-structural adhesive composition, comprising uniformly mixing components of the dual-curing semi-structural adhesive composition according to claim 1.
